(19) United States
(12) Patent Application Publication
(10) Pub. No.: US 2016/0103361 A1
(43) Pub. Date: Apr. 14, 2016

(54) COLOR FILTER, METHOD OF FABRICATING THE SAME AND DISPLAY PANEL HAVING THE SAME

(71) Applicant: Au Optronics Corporation, Hsinchu (TW)

(72) Inventors: Ya-Jung Wang, Kaohsiung City (TW); Chia-Chu Lin, Yilan County (TW); Sung-Yu Su, Tainan City (TW)

(21) Appl. No.: 14/591,009

(22) Filed: Jan. 7, 2015

(30) Foreign Application Priority Data
Oct. 9, 2014 (TW) 103135231

(51) Int. Cl. G02F 1/1335; G02B 5/20; G02F 1/1343

(52) U.S. Cl. CPC G02F 1/133514; G02F 1/133516; G02F 1/133512; G02F 1/134309; G02B 5/201

(57) ABSTRACT

A color filter is provided. The color filter includes a plurality of first color filter patterns, a plurality of second color filter patterns, a plurality of third color filter patterns and an auxiliary light-shielding layer. The auxiliary light-shielding layer is located on boundaries between the first color filter patterns and the second color filter patterns. A light absorption wavelength range of the auxiliary light-shielding layer is the same as that of the first, second, or third color filter patterns.

### CROSS-REFERENCE TO RELATED APPLICATION

This application claims the priority benefit of Taiwan application serial no. 103135231, filed on Oct. 9, 2014. The entirety of the above-mentioned patent application is hereby incorporated by reference herein and made a part of this specification.

### BACKGROUND OF THE INVENTION

1. Field of the Invention

The present invention generally relates to a display panel, and more particularly, to a color filter and a method of fabricating the same.

2. Description of Related Art

With the progress in photoelectric and semiconductor technologies, the display panel has been developed rapidly. In order to enable the display panel to display color frames, a color filter is generally disposed therein. Taking the most common liquid crystal display panel for an example, after light passed through red, green and blue color filter patterns in the color filter, a red light, a green light and a blue light can respectively be displayed, thereby achieving a color displaying effect.

In recent year, the display panel gradually develops towards the trends of compact size, lightweight, high resolution, and high pixel density. As the volume of the display panel becomes smaller, the pixel density thereof becomes higher, and when light pass through the color filter from a large angle, an observer may observe an unexpected color from a large angle side view due to an alignment error between a pixel array and the color filter in the display panel, wherein this phenomenon is referred to as a color shift. For instance, when the color expected to be observed is red, the naked eyes of the observer may simultaneously receive the light that passes through the green and red color filter patterns under the large angle side view, and thereby observe orange. Therefore, how to improve the color filter for enabling the display panel with high pixel density to have smaller color shift and favorable optical quality has become a rather important topic in the art.

### SUMMARY OF THE INVENTION

The invention is directed to a color filter and a method of fabricating the same. The color filter enables a display panel to have smaller color shift and favorable optical quality.

The invention is further directed to a display panel having a favorable visual effect when being observed from a large angle side-view.

A color filter of one of the embodiments of the invention includes a plurality of first color filter patterns, a plurality of second color filter patterns, a plurality of third color filter patterns and an auxiliary light-shielding layer. The auxiliary light-shielding layer is located on boundaries between the first color filter patterns and the second color filter patterns. A light absorption wavelength range of the auxiliary light-shielding layer is the same as that of the first color filter patterns, the second color filter patterns, or the third color filter patterns.

A color filter of one of the embodiments of the invention includes a light shielding pattern layer, a plurality of first color filter patterns, a plurality of second color filter patterns, a plurality of third color filter patterns, and an auxiliary light-shielding layer. The first color filter patterns, the second color filter patterns and the third color filter patterns are disposed on the light shielding pattern layer. The auxiliary light-shielding layer is located on boundaries between the first color filter patterns and the second color filter patterns boundaries. A light absorption wavelength range of the auxiliary light-shielding layer is different from that of the light shielding pattern layer.

A method of fabricating a color filter of one of the embodiments of the invention includes the following steps. A plurality of first color filter patterns, a plurality of second color filter patterns and a plurality of third color filter patterns are formed on a substrate. At the same time of forming the third color filter patterns, an auxiliary light-shielding layer is formed on boundaries between the first color filter patterns and the second color filter patterns.

A display panel of one of the embodiments of the invention includes a pixel array substrate, an opposite substrate, a color filter as described in above, and a display medium. The opposite substrate is located opposite to the pixel array substrate. The color filter is located on the pixel array substrate or on the opposite substrate. The display medium is located between the pixel array substrate and the opposite substrate.

In view of the above, the color filter of one of the embodiments of the invention includes the auxiliary light-shielding layer. The auxiliary light-shielding layer is located on the boundaries between the first color filter patterns and the second color filter patterns, and the light absorption wavelength range of the auxiliary light-shielding layer is the same as that of the first filter patterns, the second filter patterns or the third color filter patterns Hence, when light pass through the color filter from a large angle, the light may further be filtered by the auxiliary light-shielding layer, thereby providing a more stable wavelength range and enabling the display panel to have purer color effect in a large angle side view. In addition, the display panel includes the aforesaid color filter, and thus may have smaller color shift and favorable optical quality.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A to FIG. 1C are schematic fabrication process diagrams of a color filter according to an embodiment of the invention.

FIG. 2A to FIG. 2C are schematic cross-sectional views illustrated along a profile line A-A′ shown in FIG. 1A to FIG. 1C.

FIG. 2D is a schematic diagram illustrating the color filter 10 of FIG. 2C in a practical work situation.

FIG. 3A to FIG. 3D are schematic top views illustrating the various implementations of a color filter according to a first embodiment of the invention.

FIG. 4A illustrates a schematic cross-sectional view of another color filter according to the first embodiment of the invention.

FIG. 4B illustrates a schematic cross-sectional view of a color filter according to a second embodiment of the invention.

FIG. 5A to FIG. 5C are schematic fabrication process diagrams of a color filter according to a third embodiment of the invention.

FIG. 6 illustrates a schematic cross-sectional view of a color filter according to a fourth embodiment of the invention.

FIG. 7 illustrates a schematic cross-sectional view of a color filter according to a fifth embodiment of the invention.

FIG. 8 illustrates schematic cross-sectional view of a color filter according to a sixth embodiment of the invention.

FIG. 9 illustrates a schematic cross-sectional view of a display panel according to an embodiment of the invention.

FIG. 10A and FIG. 10B illustrate schematic cross-sectional views of a COA structure according to an embodiment of the invention.

FIG. 11A and FIG. 11B illustrate schematic cross-sectional views of a COA structure according to another embodiment of the invention.

### DESCRIPTION OF THE EMBODIMENTS

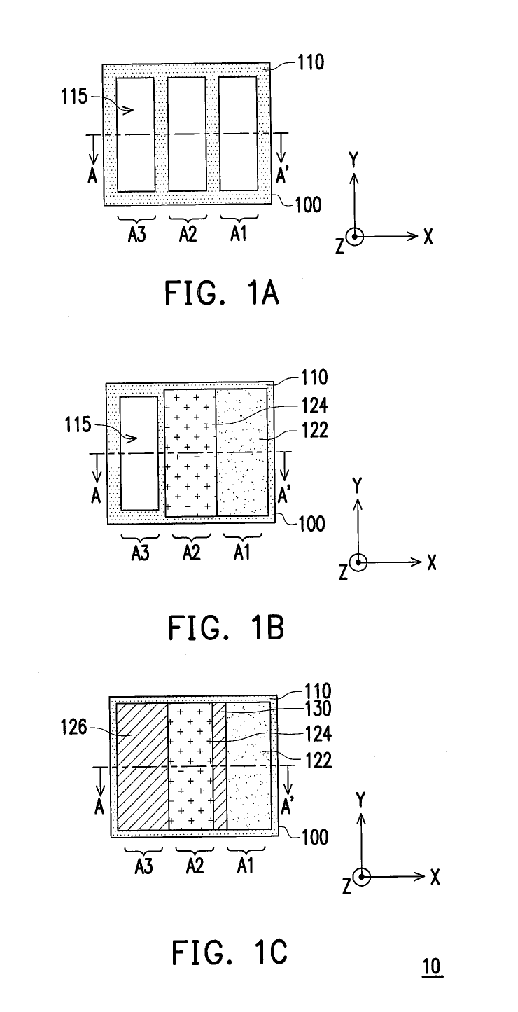

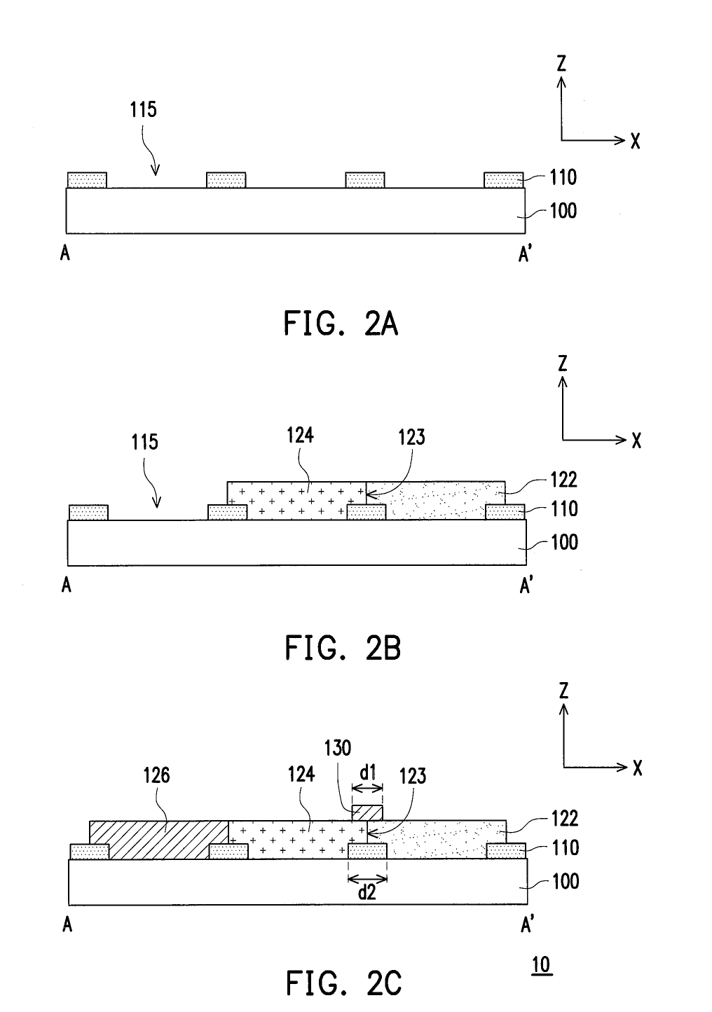

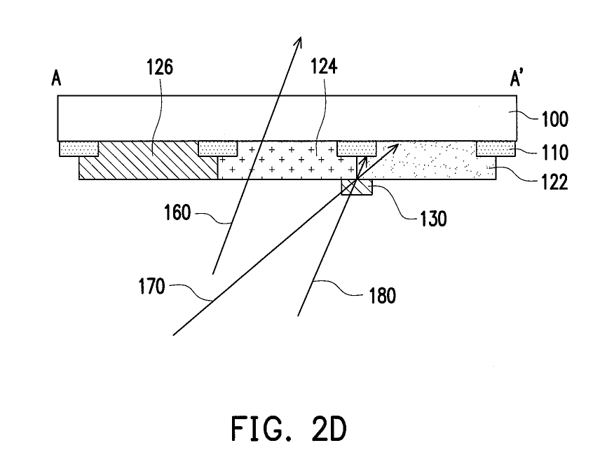

FIG. 1A to FIG. 1C are schematic fabrication process diagrams of a color filter according to an embodiment of the invention. FIG. 2A to FIG. 2C are schematic cross-sectional views illustrated along a profile line A-A′ shown in FIG. 1A to FIG. 1C. Referring to FIG. 1A and FIG. 2A, firstly, a substrate 100 is provided. A material of the substrate 100 may be glass, quartz, polymer, opaque/reflecting material (such as: electrical conductive material, metal, wafers, ceramics, or other suitable material), or other suitable material. The substrate 100 may, for example, be a pure blank substrate or a substrate already formed with other film layers or elements thereon.

Next, a light shielding pattern layer 110 is formed on the substrate 100. The light shielding pattern layer 110 divides the substrate 110 into a plurality of regions 115, and the light shielding pattern layer 110, for example, exposes a portion of the surface f of the substrate 100, wherein longer sides of the regions 115 are parallel to the Y-direction, and shorter sides thereof are parallel to the X-direction. It is to be noted that, for clear descriptions, only three regions 115 are illustrated in FIG. 1A to FIG. 1C, but those skilled in the art should understand that the light shielding pattern layer 110 may divide the substrate 110 into more regions 115 depending on the actual needs, so as to constitute an array. A material of the light shielding pattern layer 110 includes non-photosensitive material or photosensitive material. For instance, the material of the light shielding pattern layer 110 may be black resin, chromium, chromium oxide, or other opaque metal material. A light absorption wavelength range of the light shielding pattern layer 110, for example, include all of the visible lights, and thus may be observed as black under naked eyes. If the material of the light shielding pattern layer 110 is non-photosensitive material, then a method for forming the light shielding pattern layer 110 is, for example, performing a lithographic process after forming a light shielding material layer (not shown), and then patterning the light shielding material layer through using an etching process so as to complete the formation; or, directly patterning and forming the non-photosensitive material on the substrate through using a screen printing method or an inkjet coating method without undergoing exposure, developing and etching processes. If the material of the light shielding pattern layer 110 is photosensitive material, then the method for forming the light shielding pattern layer 110 is, for example, firstly performing a coating process and a curing process to form a light shielding material layer (not shown), and then directly performing exposure and developing processes to the light shielding material layer to complete the formation.

Next, referring to FIG. 1B and FIG. 2B, a plurality of first color filter patterns 122 and a plurality of second color filter patterns 124 are formed on the substrate 100. In the fabrication method of the present embodiment, the first color filter patterns 122 are formed on a same column A1 and the second color filter patterns 124 are formed on another column A2, wherein boundaries 123 between each of the first color filter patterns 122 and each of the second color filter patterns 124 are located above and overlapped with the light shielding pattern layer 110. The first color filter patterns 122 and the second color filter patterns 124 have different colors, and the colors may each be red, green or blue filter patterns. In other words, a light absorption wavelength range of the first color filter patterns 122 and a light absorption wavelength range of the second color filter patterns 124 are different, and the first color filter patterns 122 and the second color filter patterns 124 may each absorb visible lights other than the red, green and blue lights. The material of the first color filter patterns 122 and the second color filter patterns 124 may include a photoresist material, which is, for example, formed by performing red, green or blue photoresist coating, exposure, development, baking, and grinding. Moreover, the material of first color filter patterns 122 and the second color filter patterns 124 may also include a red, green or blue ink material, which is, for example, formed by performing ink printing and curing process.

Next, referring to FIG. 1C and FIG. 2C, a plurality of third color filter patterns 126 are formed in other regions 115 of the substrate 100, and at the same time, an auxiliary light-shielding layer 130 is formed on the boundaries 123 between the first color filter patterns 122 and the second color filter patterns 124. At boundaries 123, a width d1 of the longitudinal cross-section of the auxiliary light-shielding layer 130 may, for example, be smaller than or equal to a width d2 of the longitudinal cross-section of the light shielding pattern layer 110. More specifically, if observing along a cross-section of the XZ-plane direction, then the width d1 of the auxiliary light-shielding layer 130 in the X-direction is smaller than or equal to the width d2 of the light shielding pattern layer 110 in the X-direction.

In the present embodiment, the third color filter patterns 126 are formed on a same column A3, wherein column A3 is different from column A1 and column A2. A color of the third color filter patterns 126 is different from the color of the first color filter patterns 122 or the color of the second color filter patterns 124, and the third color filter patterns 126 may be red, green or blue filter patterns. In more detail, the first color filter patterns 122, the second color filter patterns 124 and the third color filter patterns 126 have different light absorption wavelength ranges, and, in generally, may each respectively absorb visible lights other than the red, green and blue lights. Namely, after the visible lights passing through the first color filter patterns 122, the second color filter patterns 124 or the third color filter patterns 126, due to a portion of the light wavelength range being absorbed, the red light, the green light or the blue light is displayed.

Material and forming method of the auxiliary light-shielding layer 130 are substantially the same as the third color filter patterns 126. Specifically, the third color filter patterns 126 and the auxiliary light-shielding layer 130 may respectively be formed on the column A3 of the substrate 100 and the boundaries 123 between the first color filter patterns 122 and the second color filter patterns 124 in a same fabrication step through using the same material, and thus a light absorption wavelength range of third color filter patterns 126 is the same as that of the auxiliary light-shielding layer 130, and the light absorption wavelength range of the auxiliary light-shielding layer 130 is different from that of the first color filter patterns 122 and the second color filter patterns 124.

On the other hand, a color filter 10 includes a substrate 100, a light shielding pattern layer 110, a plurality of first color filter patterns 122, a plurality of second color filter patterns 124, a plurality of third color filter patterns 126, and an auxiliary light-shielding layer 130. The first color filter patterns 122, the second color filter patterns 124 and the third color filter patterns 126 are located on the light shielding pattern layer 110, and the first color filter patterns 122 and the second color filter patterns 124 are respectively located between the light shielding pattern layer 110 and the auxiliary light-shielding layer 130. The auxiliary light-shielding layer 130 is located on boundaries between the first color filter patterns 122 and the second color filter patterns 124, and a light absorption wavelength range of the auxiliary light-shielding layer 130 is different from that of the light shielding pattern layer 110. For instance, the light absorption wavelength range of the auxiliary light-shielding layer 130 may be the same as that of the third color filter patterns 126, and thus is substantially being red, green or blue. The light absorption wavelength range of the light shielding pattern layer 110, for example, includes all of the visible lights, and thus is substantially black.

It is to be noted, although the color filter 10 in the present embodiment is configured with the light shielding pattern layer 110 to define a plurality of regions on the substrate 100 for forming the color filter patterns, the invention is not limited thereto. In other embodiments, the color filter 10 may also not be configured with the light shielding pattern layer 110. For instance, when the substrate 100 is, for example, a pixel array substrate, a plurality of regions for forming the color filer patterns may be defined on the substrate 100 through using the various components on the substrate 100, and thereby may omit the light shielding pattern layer 110.

At this point, all the fabrication steps of the color filter 10 are completed. Below, a practical work situation of the color filter 10 of the present embodiment, accompanied by drawings, is further described in details.

FIG. 2D is a schematic diagram illustrating the color filter 10 of FIG. 2C in the practical work situation, wherein the color filter 10 is illustrated in a vertically inverted state so as to act in concept with the practical work situation. Referring to FIG. 2D, generally, when light 160 passes through the second color filter patterns 124, light of certain wavelengths (e.g., red light and blue light) may be absorbed and lights of the remaining wavelength (e.g., green light) not being absorbed may penetrate out; whereas, light 180 is to pass through the light shielding pattern layer 110, and thus the light 180 is completely absorbed and unable to penetrate out. However, light 170 of a large angle (large viewing angle) does not pass through the light shielding pattern layer 110 and thus is unable to be absorbed by the light shielding pattern layer 110. Hence, the invention is additionally configured with the auxiliary light-shielding layer 130, so that lights (e.g., red light and green light) of certain wavelengths may be absorbed when the light 170 passes through the auxiliary light-shielding layer 130, and when the light of the remaining wavelength (e.g., blue light) not absorbed by the auxiliary light-shielding layer 130 passes through the first color filter patterns 122, lights of certain wavelengths (e.g., red light and blue light) may be absorbed. As a result, lights of all the wavelengths in the light 170 of large angle may be absorbed and will not penetrate out. Therefore, through being configured with the auxiliary light-shielding layer 130, the embodiment may absorb the light 170 of large angle, and thus prevents the performance of color purity of each pixel from being affected.

Accompanies by top views of a color filter, various implementations of the color filer according to a first embodiment of the invention are further described in details below.

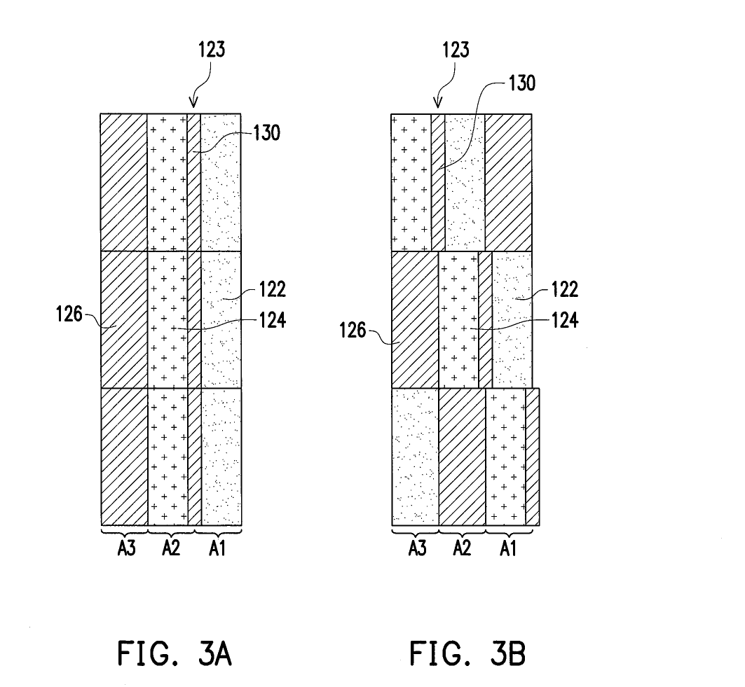

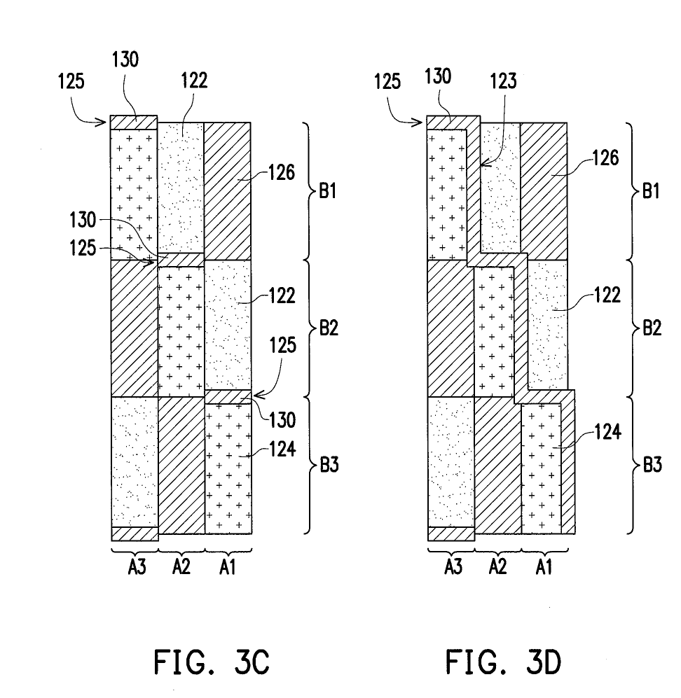

FIG. 3A to FIG. 3D are schematic top views illustrating the various implementations of a color filter according to the first embodiment of the invention. For clarity of illustration, in FIG. 3A to FIG. 3D, descriptions are provided with a 3×3 color filter pattern array. Moreover, even though the illustration of the light shielding pattern layer is omitted in FIG. 3A to FIG. 3D, those skilled in the art should understand that each color filter in FIG. 3A to FIG. 3D may selectively include the light shielding pattern layer.

Firstly, referring to FIG. 3A (illustrated as the implementation of FIG. 1C), a plurality of first color filter patterns 122 are located in a same column A1, a plurality of second color filter patterns 124 are located in another column A2, and a plurality of third color filter patterns 126 are located in still another column A3. The first color filter patterns 122, the second color filter patterns 124 and third color filter patterns 126 each has a longer side and a shorter side, and an auxiliary light-shielding layer 130 is located on boundaries 123 between the longer sides of the first color filter patterns 122 and the longer sides of the second color filter patterns 124.

In the implementation shown in FIG. 3A, since the first color filter patterns 122 and the second color filter patterns 124 are respectively disposed on column A1 and column A2, and the auxiliary light-shielding layer 130 is located on boundaries 123 between the longer sides of the first color filter patterns 122 and the longer sides of the second color filter patterns 124, the auxiliary light-shielding layer 130 may substantially located on boundaries between column A1 and column A2. The auxiliary light-shielding layer 130 is, for example, not overlapped with the third color filter patterns 126. In the present embodiment, the auxiliary light-shielding layer 130 is, for example, located on the entire boundaries 123 between the longer sides of the first color filter patterns 122 and the longer sides of the second color filter patterns 124; namely, a single auxiliary light-shielding layer 130 is appeared as a single long strip and is completely corresponded to a single direction, as shown in FIG. 3A. However, the auxiliary light-shielding layer 130 is not limited thereto, such that in a variation, a plurality of auxiliary light-shielding layers 130 not connected with each other may be sequentially arranged and completely corresponded to a single direction; that is, boundaries between four color filter patterns adjacent to each other do not have an auxiliary light-shielding layer 130 disposed thereon, and the auxiliary light-shielding layer 130 is only corresponded to a portion of the boundaries 123 between the longer sides of the first color filter patterns 122 and the longer sides of the second color filter patterns 124.

Next, referring to FIG. 3B, the implementation shown in FIG. 3B is similar to the implementation shown in FIG. 3A, except that a difference between the two lies in that: in the implementation shown in FIG. 3B, the first color filter patterns 122, the second color filter patterns 124 and the third color filter patterns 126 are staggeredly arranged with each other, and thus three different color filter patterns are disposed in a same column; contrarily, in the implementation shown in FIG. 3A, the same color filter patterns are disposed in a same column.

In more details, in the implementation shown in FIG. 3B, since the first color filter patterns 122, the second color filter patterns 124 and the third color filter patterns 126 are staggeredly arranged with each other, and the auxiliary light-shielding layer 130 is only located on the boundaries 123 between the longer sides of the first color filter patterns 122 and the longer sides of the second color filter patterns 124 but not on boundaries between the longer sides of the first color filter patterns 122 an the longer sides of the third color filter patterns 126 or on boundaries between the longer sides of the second color filter patterns 124 and the longer sides of the third color filter patterns 126, the auxiliary light-shielding layer 130 is, for example, not overlapped with the third color filter patterns 126. Particularly, when the third color filter pattern 126 is not located in the most outer side of a row or column of the array, the auxiliary light-shielding layer 130 may be located in the most outer side, such as being located on an outer longer side of the second color filter pattern 124 at an outer edge of the array, as shown in the lower right of FIG. 3B.

Next, referring to FIG. 3C, the implementation shown in FIG. 3C is similar to the implementation shown in FIG. 3B, except that a difference between the two lies in that: in the implementation shown in FIG. 3C, the auxiliary light-shielding layer 130 is located on boundaries 125 between the shorter sides of the first color filter patterns 122 and the shorter sides of the second color filter patterns 124; contrarily, in the implementation shown in FIG. 3B, the auxiliary light-shielding layer 130 is located on boundaries 123 between the longer sides of the first color filter patterns 122 and the longer sides of the second color filter patterns 124. The auxiliary light-shielding layer 130, for example, is not overlapped with the third color filter patterns 126.

In more details, in the implementation shown in FIG. 3C, since the first color filter patterns 122, the second color filter patterns 124 and the third color filter patterns 126 are staggeredly arranged with each other, and the auxiliary light-shielding layer 130 are located on the boundaries 125 between the shorter sides of the first color filter patterns 122 and the shorter sides of the second color filter patterns 124, each portion of the auxiliary light-shielding layer 130 is substantially only located the boundaries 125 between the shorter sides of the first color filter patterns 122 and the shorter sides of the second color filter patterns 124, respectively, but not on boundaries between the shorter sides of the first color filter patterns 122 and the shorter sides of the third color filter patterns 126 or boundaries between the shorter sides of the second color filter patterns 124 and shorter sides of the third color filter patterns 126. Particularly, when the third color filter pattern 126 is not located in the most outer side of a row or column of the array, the auxiliary light-shielding layer 130 may be located in the most outer side, such as being located on an outer shorter side of the second color filter pattern 124 at an outer edge of the array, as shown in the upper left of FIG. 3C.

Next, referring to FIG. 3D, the implementation shown in FIG. 3D is similar to the implementation shown in FIG. 3B, except that a difference between the two lies in that: in the implementation shown in FIG. 3D, the auxiliary light-shielding layer 130 is simultaneously located on the boundaries 123 between the longer sides of the first color filter patterns 122 and the longer sides of the second color filter patterns 124 and on the boundaries 125 between the shorter sides of the first color filter patterns 122 and the shorter sides of the second color filter patterns 124; contrarily, in the implementation shown in FIG. 3B, the auxiliary light-shielding layer 130 is only located on the boundaries 123 between the longer sides of the first color filter patterns 122 and the longer sides of the second color filter patterns 124.

In more details, in the implementation shown in FIG. 3D, the first color filter patterns 122, the second color filter patterns 124 and the third color filter patterns 126 are staggeredly arranged with each other, and the auxiliary light-shielding layer 130 is simultaneously located on the longer side boundaries 123 and the shorter side boundaries 125 between the first color filter patterns 122 and the second color filter patterns 124, but the auxiliary light-shielding layer 130 is not located on the longer side/shorter side boundaries between the first color filter patterns 122 and the third color filter patterns 126 or longer side/shorter side boundaries between the second color filter patterns 124 and the third color filter patterns 126. Particularly, when the third color filter pattern 126 is not located in the most outer side of a row or column of the array, the auxiliary light-shielding layer 130 may be located in the most outer side, such as being located on an outer longer side of the second color filter pattern 124 at an outer edge of the array and on an outer shorter side of the second color filter pattern 124 at an outer edge of the array, as shown in the lower right and the upper left of FIG. 3C.

It is to be noted that, in the implementations shown in FIG. 3A to FIG. 3D, for clarity of descriptions, only the conditions of the auxiliary light-shielding layer 130 being located on the boundaries 123 between all the longer sides of the first color filter patterns 122 and the second color filter patterns 124 and/or on the boundaries 125 between all the shorter sides of the first color filter patterns 122 and the second color filter patterns 124 are illustrated. However, those skilled in the art should be able to understand that the auxiliary light-shielding layer 130 may also be selectively disposed on certain longer side boundaries 123 and/or on certain shorter side boundaries 125 rather than on all the longer side boundaries 123 and/or all the shorter side boundaries 125. In other words, in the present embodiment, the auxiliary light-shielding layer 130 may be formed on certain longer side boundaries 123 and/or certain shorter side boundaries 125, rather than on all the longer side boundaries 123 and/or all the shorter side boundaries 125.

The color filter 10 of the present embodiment includes the auxiliary light-shielding layer 130. The auxiliary light-shielding layer 130 is disposed on the longer side boundaries 123 and/or the shorter side boundaries 125 between the first color filter patterns 122 and the second color filter patterns 124, and the light absorption wavelength range of the auxiliary light-shielding layer 130 is the same as that of the third color filter patterns 126. Therefore, when only wanting to observe the light from the first color filter patterns 122 under a large viewing angle (namely, when only wanting to observe the color displayed by the first color filter patterns 122), the auxiliary light-shielding layer 130 may only allow light penetrable through the third color filter patterns 126 to pass, and then the light would be absorbed by the first color filter patterns 122 when passing through the first color filter patterns 122, so that a user may only observe the color displayed by the first color filter patterns 122, thereby further improving the observed color purity. Similarity, when only wanting to observe the light from the second color filter patterns 124 under a large viewing angle, the auxiliary light-shielding layer 130 may only allow light penetrable through the third color filter patterns 126 to pass, and then the light would be absorbed by the second color filter patterns 124 when passing through the second color filter patterns 124, so that the user may only observe the color displayed by the second color filter patterns 124. In addition, since the auxiliary light-shielding layer 130 and the third color filter patterns 126 may be simultaneously formed, no additional processing step is required to form the auxiliary light-shielding layer 130.

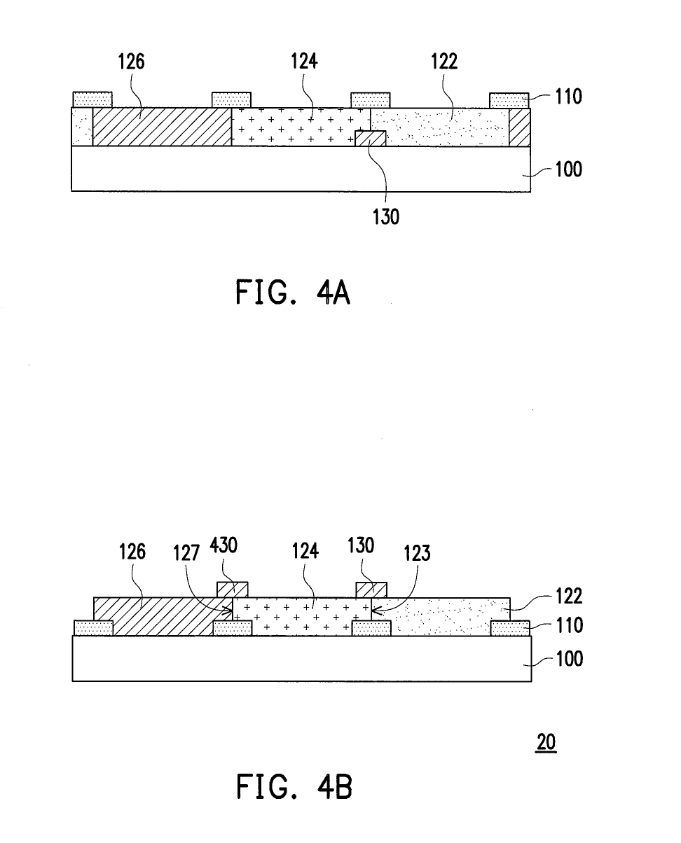

FIG. 4A illustrates a schematic cross-sectional view of another color filter according to the first embodiment of the invention. Referring to FIG. 4A, the color filter of FIG. 4A is similar to the color filter of FIG. 2C, and differences between the two lies in that the first color filter patterns 122, the second color filter patterns 124 and the third 126 are being formed after the auxiliary light-shielding layer 130 is disposed on the substrate 100; and the light shielding pattern layer 110 is disposed on the first color filter patterns 122, the second color filter patterns 124 and the third 126. In other words, relative positions of the auxiliary light-shielding layer 130 and the light shielding pattern layer 110 in the color filter of FIG. 4A are different from that of the auxiliary light-shielding layer 130 and the light shielding pattern layer 110 in the color filter of FIG. 2C.

FIG. 4B illustrates a schematic cross-sectional view of a color filter according to a second embodiment of the invention. The color filter 20 shown in the second embodiment is similar to that of the first embodiment, and thus same reference numerals refer to the same or similar elements and detailed descriptions thereof will no be repeated.

Referring to FIG. 4B, similar to the first embodiment, the first color filter patterns 122, the second color filter patterns 124 and the third color filter patterns 126 are respectively formed on the substrate 100 which is configured with the light shielding pattern layer 110, the auxiliary light-shielding layer 130 is formed on the boundaries 123 between the first color filter patterns 122 and the second color filter patterns 124, and another auxiliary light-shielding layer 430 is formed on boundaries 127 between the second color filter patterns 124 and the third color filter patterns 126 so as to complete all the fabrication steps of the color filter 20.

Differences between the color filter 20 of the present embodiment and the color filter 10 of the first embodiment lie in that: the color filter 20 further include another auxiliary light-shielding layer 430 on the boundaries 127 between the second color filter patterns 124 and the third color filter patterns 126, and the auxiliary light-shielding layer 430 is similar to the auxiliary light-shielding layer 130. Material and forming method of the auxiliary light-shielding layer 130 and the auxiliary light-shielding layer 430 are substantially the same as the third color filter patterns 126. Specifically, the third color filter patterns 126 and the auxiliary light-shielding layer 130 may respectively be formed on the substrate 100 and the boundaries 123 between the first color filter patterns 122 and the second color filter patterns 124 in a same fabrication step through using the same material, and at the same time, the auxiliary light-shielding layer 430 may also be formed on the boundaries 127 between the second color filter patterns 124 and the third color filter patterns 126. In more details, in addition to forming the auxiliary light-shielding layer 130 on the boundaries 123 between the first color filter patterns 122 and the second color filter patterns 124, another auxiliary light-shielding layer 430 may also be formed on the boundaries 127 between the second color filter patterns 124 and the third color filter patterns 126, and a light absorption wavelength range of the auxiliary light-shielding layer 430 is the same as that of the third color filter patterns 126 and the auxiliary light-shielding layer 130. Therefore, when only wanting to observe the light from the third color filter patterns 126, the auxiliary light-shielding layer 430 may only allow light penetrable through the third color filter patterns 126 to pass and absorb light penetrable through the first color filter patterns 122 and the second color filter patterns 124; the remaining the principles are the same as previously described in the above, and thus will not be repeated.

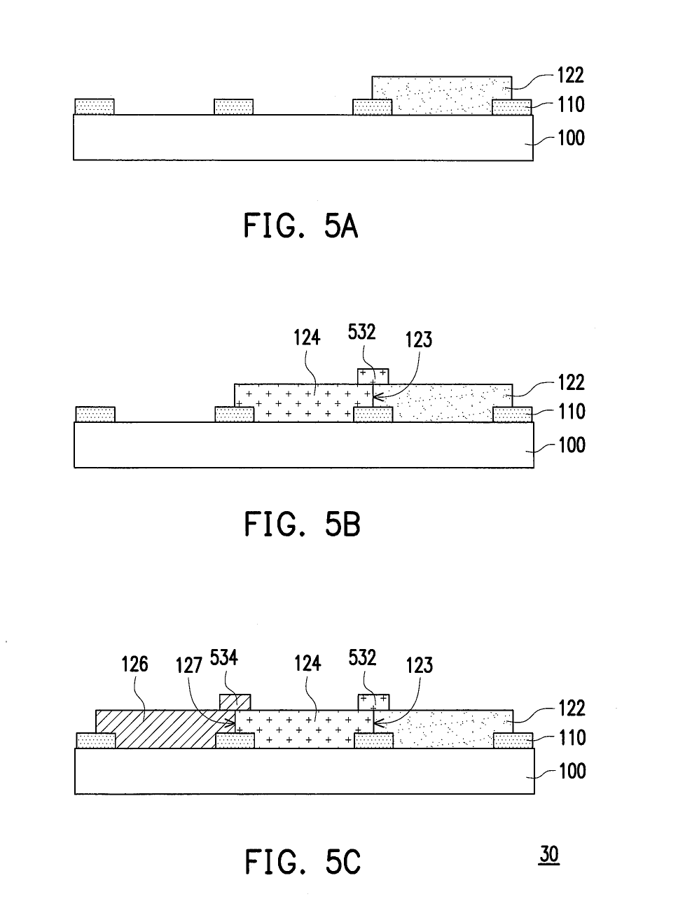

FIG. 5A to FIG. 5C are schematic fabrication process diagrams of a color filter according to a third embodiment of the invention. The fabrication process of the color filter 30 shown in the third embodiment is similar to that of the color filter 10 of the first embodiment, and thus same reference numerals refer to the same or similar elements and detailed descriptions thereof will no be repeated.

Referring to FIG. 5A, the first color filter patterns 122 are formed on the substrate 100 which is configured with the light shielding pattern layer 110.

Next, referring to FIG. 5B, the second color filter patterns 124 and a first auxiliary light-shielding pattern 532 may respectively be formed on the substrate 100 and the boundaries 123 between the first color filter patterns 122 and the second color filter patterns 124 in a same fabrication step through using the same material. Hence, the light absorption wavelength range of the second color filter patterns 124 is the same as that of the first auxiliary light-shielding pattern 532, and the light absorption wavelength range of the first auxiliary light-shielding pattern 532 is different from that of the first color filter patterns 122. In addition, since the first auxiliary light-shielding pattern 532 is formed on the boundaries between the first color filter patterns 122 and the second color filter patterns 124, the first color filter patterns 122 and the second color filter patterns 124 are located between the light shielding pattern layer 110 and the first auxiliary light-shielding pattern 532. The light absorption wavelength range of the first auxiliary light-shielding pattern 532 is the same as that of the second color filter patterns 124, and thus the first auxiliary light-shielding pattern 532 may only allow light penetrable through the second color filter patterns 124 to pass, thereby only allowing the light from the second color filter patterns 124 to be observed from a large angle side view.

Finally, referring to FIG. 5C, the third color filter patterns 126 and a second auxiliary light-shielding layer 534 may respectively be formed on the substrate 100 and the boundaries 127 between the second color filter patterns 124 and the third color filter patterns 126 in a same fabrication step through using the same material, so that the second color filter patterns 122 and the third color filter patterns 126 are located between the light shielding pattern layer 110 and the second auxiliary light-shielding pattern 534. A light absorption wavelength range of the second auxiliary light-shielding pattern 534 is the same as that of the third color filter patterns 126, and thus the light absorption wavelength range of the second auxiliary light-shielding pattern 534 is different from that of the first color filter patterns 122 and the second color filter patterns 124. The light absorption wavelength range of the second auxiliary light-shielding pattern 534 is the same as the third color filter patterns 126, and thus the second auxiliary light-shielding pattern 534 may only allow light penetrable through the third color filter patterns 126 to pass, thereby only allowing the light from the third color filter patterns 126 to be observed from a large angle side view. At this point, all the fabrication steps of the color filter 30 of the present embodiment are finished.

In more details, a difference between the color filter 30 of the present embodiment and the color filter 10 of the first embodiment lies in that: in the color filter 30, the auxiliary light-shielding layer includes the first auxiliary light shielding pattern 532 and the second auxiliary light shielding pattern 534. The first auxiliary light shielding pattern 532 is located on the boundaries 123 between the first color filter patterns 122 and the second color filter patterns 124, and the second auxiliary light shielding pattern 534 is located on the boundaries 127 between the second color filter patterns 124 and the third color filter patterns 126. The light absorption wavelength range of the first auxiliary light shielding pattern 532 is different from that of the second auxiliary light shielding pattern 534, and the light absorption wavelength range of the first auxiliary light shielding pattern 532 and the light absorption wavelength range of the second auxiliary light shielding pattern 534 may each be the same as the light absorption wavelength range light of the second color filter patterns 124 and the light absorption wavelength range of the third color filter patterns 126. Therefore, when observing from the large angle side view, the first auxiliary light shielding pattern 532 and the second auxiliary light shielding pattern 534 may respectively allow only the light penetrable through the second color filter patterns 124 and the third color filter patterns 126 to pass, thereby enhancing the observed visual quality. However, the invention is not limited thereto. In other embodiments, the light absorption wavelength range of the first auxiliary light-shielding pattern 532 may also be the same as that of the first color filter patterns 122 or the third color filter patterns 126, and the light absorption wavelength range of the second auxiliary light-shielding pattern 534 may also be the same as that of the first color filter patterns 122 or the second color filter patterns 124. Herein, since there may be a variety of permutations and combinations, no further elaboration will be provided. To sum it up, those skilled in the art can design the light absorption wavelength ranges for the first auxiliary light shielding pattern 532 and the second auxiliary light shielding pattern 534 according to the practical needs, whereby those designs still fall within the scope or spirit of the invention.

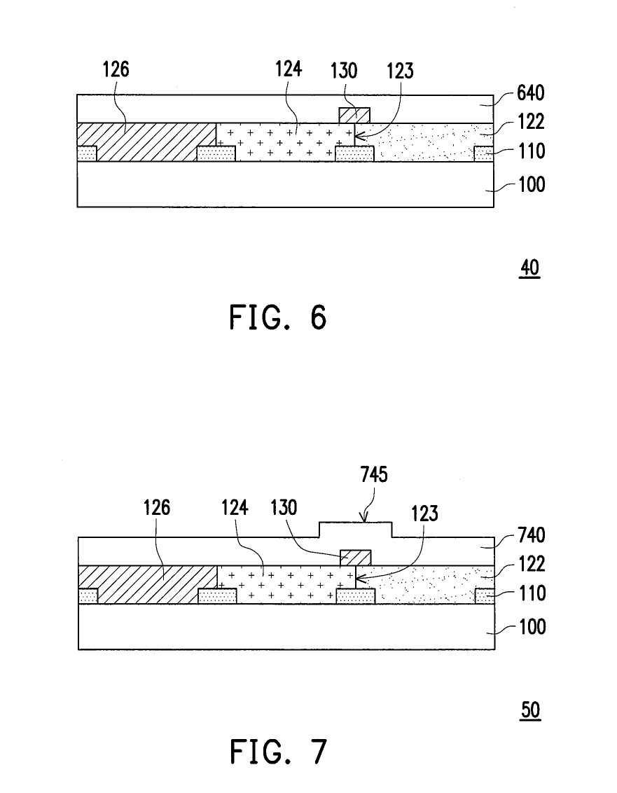

FIG. 6 illustrates a schematic cross-sectional view of a color filter according to a fourth embodiment of the invention. The color filter 40 of the fourth embodiment is similar to the color filter 10 of the first embodiment, and thus same reference numerals refer to the same or similar elements and detailed descriptions thereof will no be repeated.

Referring to FIG. 6, similar to the first embodiment, the first color filter patterns 122, the second color filter patterns 124 and the third color filter patterns 126 are respectively formed on the substrate 100 which is configured with the light shielding pattern layer 110, and the auxiliary light-shielding layer 130 is formed on the boundaries 123 between the first color filter patterns 122 and the second color filter patterns 124. Next, a planar layer 640 is formed on the substrate 100, and the planar layer 640 covers the auxiliary light-shielding layer 130, the first color filter patterns 122, the second color filter patterns 124, and the third color filter patterns 126. The planar layer 640 is, for example, an un-patterned film, and a material thereof is, for example, inorganic material (e.g.: silicon oxide, silicon nitride, silicon oxynitride, other suitable material, or a stacked layer constituted by at least two of the above), organic material (e.g.: polyester (PET), polyolefin, polypropylene acyl, polycarbonate, polyalkylene oxide, polyphenylene alkene, polyether, polyketone, polyvinyl alcohol, poly aldehyde, other suitable material, or a combination thereof), other suitable material, or a combination thereof. At this point, all the fabrication steps of the color filter 40 of the present embodiment are finished.

FIG. 7 illustrates a schematic cross-sectional view of a color filter according to a fifth embodiment of the invention. The color filter 50 of the fifth embodiment is similar to the color filter 50 of the fourth embodiment, and thus same reference numerals refer to the same or similar elements and detailed descriptions thereof will no be repeated.

Referring to FIG. 7, similar to the fourth embodiment, the first color filter patterns 122, the second color filter patterns 124 and the third color filter patterns 126 are respectively formed on the substrate 100 which is configured with the light shielding pattern layer 110, and the auxiliary light-shielding layer 130 is formed on the boundaries 123 between the first color filter patterns 122 and the second color filter patterns 124. Next, a cover layer 740 is formed on the substrate 100, and the cover layer 740 covers the auxiliary light-shielding layer 130, the first color filter patterns 122, the second color filter patterns 124, and the third color filter patterns 126. Forming method and material of the cover layer 740 are similar to that of the planar layer 640 of the color filter 40, except a difference between the two lies in that: the cover layer 740 is conformally disposed on the substrate 100, and thus a protrusion 745 may be formed above the auxiliary light-shielding layer 130. At this point, all the fabrication steps of the color filter 50 of the present embodiment are finished.

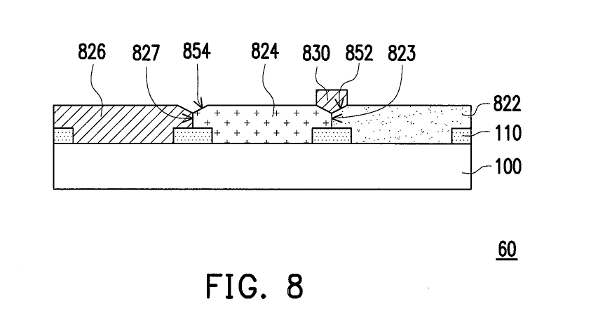

FIG. 8 illustrates schematic cross-sectional view of a color filter according to a sixth embodiment of the invention. The color filter 60 of the sixth embodiment is similar to the color filter 10 of the first embodiment, and thus same reference numerals refer to the same or similar elements and detailed descriptions thereof will no be repeated.

Referring to FIG. 8, a plurality of first color filter patterns 822, a plurality of second color filter patterns 824 and a plurality of third color filter patterns 826 are respectively formed on the substrate 100 which is configured with the light shielding pattern layer 110, wherein a recess 852 is formed on boundaries 823 between the first color filter patterns 822 and the second color filter patterns 824, and a recess 854 is formed on boundaries 827 between the second color filter patterns 824 and the third color filter patterns 826. Next, an auxiliary light-shielding layer 830 fills the recess 852. Namely, the auxiliary light-shielding layer 830 is formed on the boundaries 823 between the first color filter patterns 822 and the second color filter patterns 824. More specifically, since the recess 852 is formed at the boundaries 823 between the first color filter patterns 822 and the second color filter patterns 824, the auxiliary light-shielding layer 830 may directly be filled into the recess 852. At this point, all the fabrication steps of the color filter 60 of the present embodiment are finished.

It is to be noted that, in the second embodiment to the sixth embodiment, in clarity of the illustration, top views of the various implementations of the each embodiment are not provided. However, those skilled in the art should be able to apply the various implementations (including drawings shown in FIG. 3A to FIG. 3D) of the first embodiment onto the second to sixth embodiments, so as to produce various modifications and appropriate changes. It should be understood that, those modifications or changes still fall within the scope of the invention. In addition, other film or element (e.g., a pixel array) may further be formed on the various color filters described in the above, and thereby constitute array structures on the color filters.

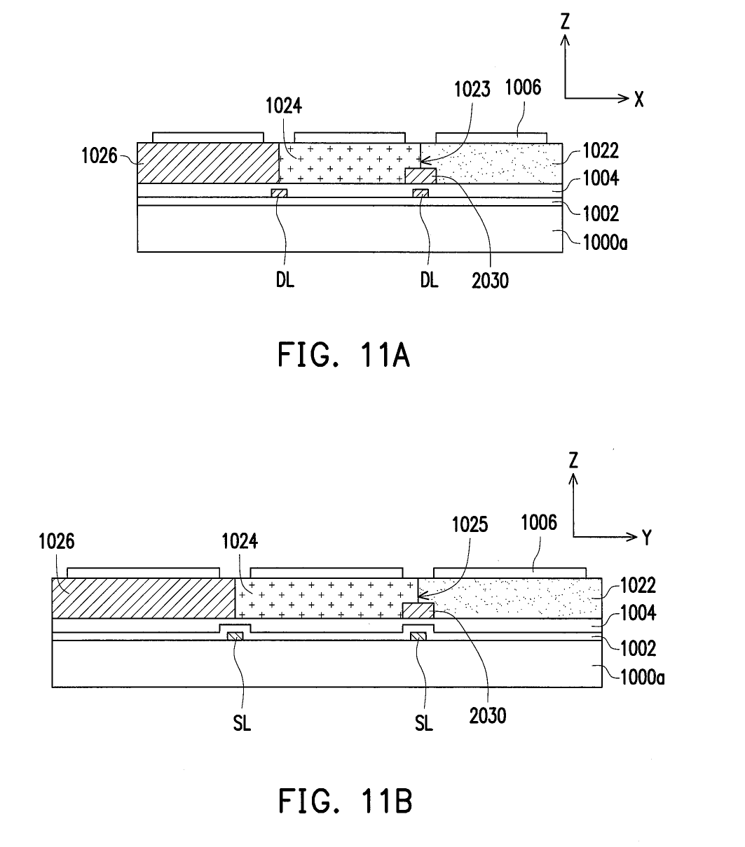

Moreover, in the previous embodiments, the auxiliary light-shielding layer is always disposed on the color filter patterns. However, it should be understood that, the auxiliary light-shielding layer of the invention may also be disposed between the substrate and the color filter patterns (as shown in FIG. 11A and FIG. 11B), so that the light may sequentially pass through the color filter patterns and the auxiliary light-shielding layer to achieve a color purification effect.

The color filters of the various embodiments of the invention and the implementations thereof, together with the drawings, are already described in the above. In the following contents, applications of the filter patterns in a display panel, together with drawings, are provided.

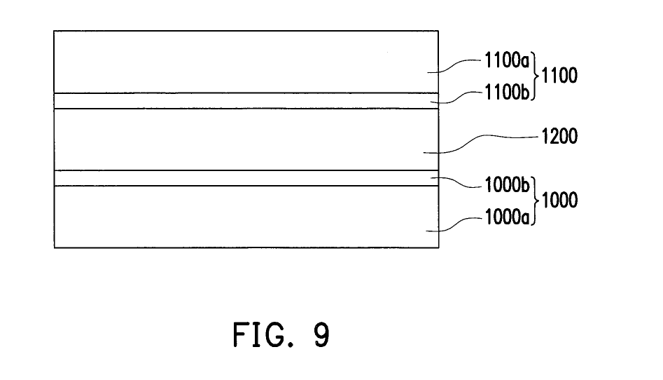

FIG. 9 illustrates a schematic cross-sectional view of a display panel according to an embodiment of the invention. Referring to FIG. 9, a display panel includes a pixel array substrate 1000, an opposite substrate 1100 and a display medium 1200. The pixel array substrate 1000 includes a substrate 1000a and a pixel array layer 1000b. A material of the substrate 1000a may be glass, quartz, polymer, or opaque/reflecting material (e.g.: electrically conductive material, metal, wafer, ceramic, or other suitable material), or other suitable material. The pixel array layer 1000b is disposed on the substrate 1000a, and the pixel array layer 1000b includes a pixel array (not shown). In general, the pixel array includes a plurality of scan lines, a plurality of data lines, a plurality of active devices, and a plurality of pixel electrodes.

The opposite substrate 1100 is located opposite to the pixel array substrate 1000. The opposite substrate 1100 includes a substrate 1100a and a color filter 1100b. A material of the opposite substrate 1100a is similar to that of the substrate 1000a of the pixel array substrate 1000, which includes lass, quartz, polymer, or opaque/reflecting material (e.g.: electrically conductive material, metal, wafer, ceramic, or other suitable material), or other suitable material. The color filter 1100b is disposed on the opposite substrate 1100a, and the color filter 1100b is, for example, one the various color filters described in the previous embodiments.

The display medium 1200 is located between the pixel array substrate 1000 and the opposite substrate 1100, and the display medium 1200 may include liquid crystal molecules, electrophoretic display medium, or other suitable media.

In some embodiments, as shown in FIG. 1 to FIG. 8, the color filter of the invention may be disposed on the blank substrate 1100a to constitute a portion of the opposite substrate 1100.

However, the present embodiment is not limited thereto. In some other embodiments, the color filter of the invention may further be disposed on the substrate 1000a to constitute a portion of the pixel array substrate 1000, an this type of structure is generally referred to as a color filter on array (COA) structure. In the following, detail descriptions regarding an application of the color filter of the invention on a COA structure are provided.

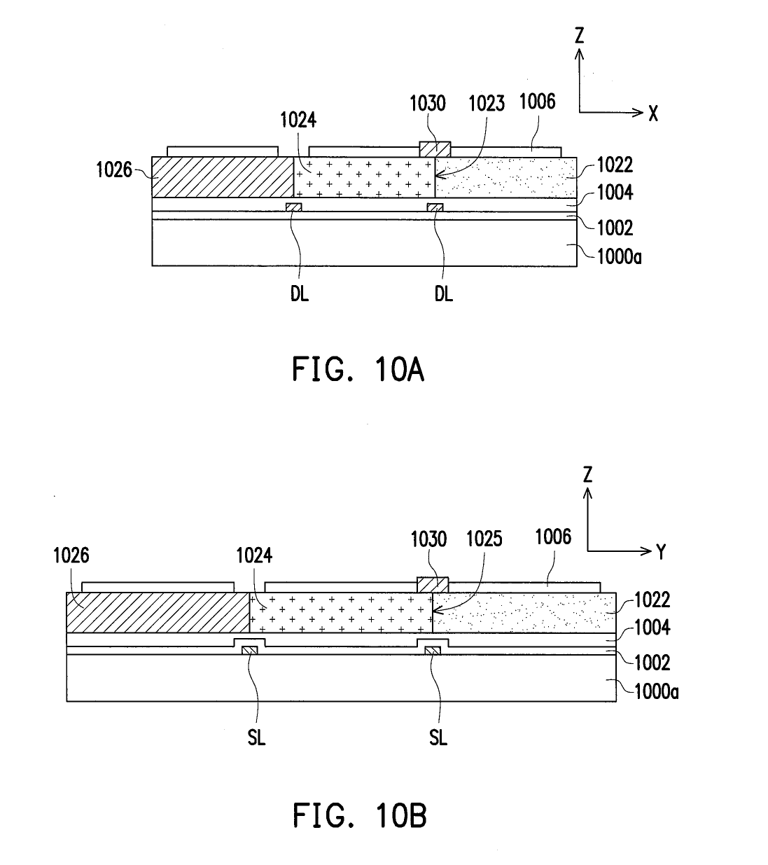

FIG. 10A and FIG. 10B illustrate schematic cross-sectional views of a COA structure according to an embodiment of the invention, wherein directions of profile lines in FIG. 1 OA and FIG. 10B are perpendicular to each other (such as the X-direction and the Y-direction that are perpendicular to each other). Referring to FIG. 10A and FIG. 10B at the same time, a plurality of scan lines SL, a plurality of data lines DL, a plurality of active devices (not shown) and a plurality of pixel electrodes 1006 are formed on a substrate 1000a. The scan lines SL (parallel to the X-direction) and the data lines DL (parallel to the Y-direction) are staggeredly disposed with each other, and the scan lines SL and the data lines DL are respectively covered by a first insulating layer 1002 and a second insulating layer 1004. The active devices (not shown) are each electrically connected with the corresponding scan line SL and the corresponding data line DL, and the pixel electrodes 1006 are electrically connected with the corresponding active devices through contact windows (not shown), so that the active devices and the pixel electrodes 1006 may be controlled through the corresponding scan lines SL and the corresponding data lines DL. In the present embodiment, the substrate 1000a is formed with a plurality of first color filter patterns 1022, a plurality of second color filter patterns 1024, a plurality of third color filter patterns 1026, and an auxiliary light-shielding layer 1030 thereon, and the auxiliary light-shielding layer 1030 is disposed on boundaries 1023 and 1025 between the first color filter patterns 1022 and the second color filter patterns 1024.

FIG. 11A and FIG. 11B illustrate schematic cross-sectional views of a COA structure according to another embodiment of the invention, wherein directions of profile lines in FIG. 11A and FIG. 11B are perpendicular to each other (such as the X-direction and the Y-direction that are perpendicular to each other). Referring to FIG. 11A and FIG. 11B at the same time, the present embodiment is similar to the embodiment shown in FIG. 10A and FIG. 10B, except a difference between the two lies in that: in the embodiment shown in FIG. 11A and FIG. 11B, an auxiliary light-shielding layer 2030 is disposed on an insulation layer 1004 and located between the first color filter patterns 122 and the second color filter patterns 124, rather than disposed on the color filter patterns. In other words, in the present embodiment, the auxiliary light-shielding layer 2030 is disposed between an active device array and the filter patterns rather than disposed on the filter patterns.

Referring to FIG. 10A and FIG. 11A, when the auxiliary light-shielding layer 1030 or 2030 is disposed on the boundaries 1023 (similar to the longer side boundaries described in the above) between the first color filter patterns 1022 and the second color filter patterns 1024 in the X-direction, the auxiliary light-shielding layer 1030 may be disposed corresponding to one of the data lines DL. Moreover, referring to FIG. 10 and FIG. 11B, when the auxiliary light-shielding layer 1030 is disposed on the boundaries 1025 (similar to the shorter side boundaries described in the above) between the first color filter patterns 1022 and the second color filter patterns 1024 in the Y-direction, the auxiliary light-shielding layer 1030 may be disposed corresponding to one of the scan lines SL. In other words, when the color filter of the invention is applied on a pixel array substrate to form a COA structure, the auxiliary light-shielding layer 1030 may be disposed corresponding to at least one of the data lines DL and the scan lines SL.

In summary, the color filter of the invention includes the auxiliary light-shielding layer. For requirements of visual design, the auxiliary light-shielding layer may selectively be disposed on various boundaries between the color filter patterns, and the light absorption wavelength range of the auxiliary light-shielding layer may also selectively be the same as that of the various color filter patterns. Therefore, the auxiliary light-shielding layer may absorb the light from the unintended color filter patterns, so as to further enhance the filter efficacy of the color filter and improve the optical quality of the display panel of the color filter. In addition, since the material of the auxiliary light-shielding layer of the invention is the same as that of the color filter patterns, and may even be formed in the same processing step as the color filter patterns, it does not require much additional fabrication cost to produce the auxiliary light-shielding layer.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A color filter, comprising:
a plurality of first color filter patterns, a plurality of second color filter patterns and a plurality of third color filter patterns; and
an auxiliary light-shielding layer, located on boundaries between the first color filter patterns and the second color filter patterns, wherein a light absorption wavelength range of the auxiliary light-shielding layer is the same as that of the first color filter patterns, the second color filter patterns, or the third color filter patterns.

2. The color filter as recited in claim 1, wherein the light absorption wavelength range of the auxiliary light-shielding layer is different from that of the first color filter patterns and the second color filter patterns.

3. The color filter as recited in claim 1, wherein the auxiliary light-shielding layer is further located on boundaries between the second color filter patterns and the third color filter patterns.

4. The color filter as recited in claim 3, wherein the light absorption wavelength range of the auxiliary light-shielding layer is different from that of the first color filter patterns and the second color filter patterns, and the light absorption wavelength range of the auxiliary light-shielding layer is the same as that of the third color filter patterns.

5. The color filter as recited in claim 3, further comprising a light shielding pattern layer, the first color filter patterns, the second color filter patterns and the third color filter patterns are located between the light shielding pattern layer and the auxiliary light-shielding layer, and the light absorption wavelength range of the auxiliary light-shielding layer is different from that of the light shielding pattern layer.

6. The color filter as recited in claim 1, wherein the auxiliary light-shielding layer comprises a first auxiliary light shielding pattern and a second auxiliary light shielding pattern, the first auxiliary light shielding pattern is located on boundaries between the first color filter patterns and the second color filter patterns, the second auxiliary light shielding pattern is located on boundaries between the second color filter patterns and the third color filter patterns, and a light absorption wavelength range of the first auxiliary light shielding pattern is different from that of the second auxiliary light shielding pattern.

7. The color filter as recited in claim 6, wherein the light absorption wavelength range of the first auxiliary light-shielding pattern is the same as that of the second color filter patterns, and the light absorption wavelength range of the second auxiliary light-shielding pattern is the same as that of the third color filter patterns.

8. The color filter as recited in claim 1, further comprising a light shielding pattern layer, the first color filter patterns and the second color filter patterns are located between the light shielding pattern layer and the auxiliary light-shielding layer, and the light absorption wavelength range of the auxiliary light-shielding layer is different from that of the light shielding pattern layer.

9. The color filter as recited in claim 8, wherein a width of the longitudinal cross-section of the auxiliary light-shielding layer is smaller than or equal to that of the longitudinal cross-section of the light shielding pattern layer.

10. The color filter as recited in claim 1, further comprising a planar layer or a cover layer, covering the auxiliary light-shielding layer, the first color filter patterns, the second color filter patterns and the third color filter patterns.

11. The color filter as recited in claim 1, wherein each of the boundaries between the first color filter patterns and the second color filter patterns has a recess, and the auxiliary light-shielding layer fills the recess.

12. The color filter as recited in claim 1, wherein the first color filter patterns, the second color filter patterns and the third color filter patterns respectively has a longer side and a shorter side, and the auxiliary light-shielding layer is located on the boundaries between the longer sides of the first color filter patterns and the longer sides of the second color filter patterns.

13. The color filter as recited in claim 1, wherein the first color filter patterns, the second color filter patterns and the third color filter patterns respectively has a longer side and a shorter side, and the auxiliary light-shielding layer is located on the boundaries between the shorter sides of the first color filter patterns and the shorter sides of the second color filter patterns.

14. The color filter as recited in claim 1, wherein the first color filter patterns, the second color filter patterns and the third color filter patterns respectively has a longer side and a shorter side, the auxiliary light-shielding layer is located on at least one of the boundaries between the longer sides of the first color filter patterns and the longer sides of the second color filter patterns, and/or the auxiliary light-shielding layer is located on at least one of the boundaries between the shorter sides of the first color filter patterns and the shorter sides of the second color filter patterns.

15. A color filter, comprising:
a light shielding pattern layer;
a plurality of first color filter patterns, a plurality of second color filter patterns and a plurality of third color filter patterns, disposed on the light shielding pattern layer; and
an auxiliary light-shielding layer, located on boundaries between the first color filter patterns and the second color filter patterns, and a light absorption wavelength range of the auxiliary light-shielding layer is different from that of the light shielding pattern layer.

16. A method of fabricating a color filter, comprising:
forming a plurality of first color filter patterns, a plurality of second color filter patterns and a plurality of third color filter patterns on a substrate, wherein at the same time of forming third color filter patterns, further comprising forming an auxiliary light-shielding layer on boundaries between the first color filter patterns and the second color filter patterns.

17. The method of fabricating the color filter as recited in claim 16, wherein the auxiliary light-shielding layer is located on boundaries between the second color filter patterns and the third color filter patterns.

18. The method of fabricating the color filter as recited in claim 16, further comprising forming a light shielding pattern layer on the substrate, wherein the first color filter patterns and the second color filter patterns are located between the light shielding pattern layer and the auxiliary light-shielding layer, and a light absorption wavelength range of the auxiliary light-shielding layer is different from that of the light shielding pattern layer.

19. A method of fabricating a color filter, comprising:
forming a plurality of first color filter patterns, a plurality of second color filter patterns and a plurality of third color filter patterns on a substrate; and
forming a first auxiliary light-shielding pattern on the boundaries between the first color filter patterns and the second color filter patterns, and forming a second auxiliary light-shielding pattern on the boundaries between the second color filter patterns and the third color filter patterns, wherein a light absorption wavelength range of the first auxiliary light-shielding pattern is the same as that of the second color filter patterns, and a light absorption wavelength range of the second auxiliary light-shielding pattern is the same as that of the third color filter patterns.

20. The method of fabricating the color filter as recited in claim 19, further comprising forming a light shielding pattern layer on the substrate, the first color filter patterns and the second color filter patterns are located between the light shielding pattern layer and the first auxiliary light-shielding pattern, the second color filter patterns and the third color filter patterns are located between the light shielding pattern layer and the second auxiliary light-shielding pattern, and the light absorption wavelength ranges of the first auxiliary light-shielding pattern, the second auxiliary light-shielding pattern and the light shielding pattern layer are all different.

21. A display panel, comprising:
a pixel array substrate;
an opposite substrate, disposed opposite to the pixel array substrate;
the color filter as recited in claim 1, disposed on the pixel array substrate or on the opposite substrate; and
a display medium, located between the pixel array substrate and the opposite substrate.

22. The display panel as recited in claim 21, wherein the pixel array substrate comprises a pixel array, the pixel array comprising:
a plurality of scan lines and a plurality data lines;
a plurality of active devices, electrically connected with the scan lines and the data lines; and
a plurality of pixel electrodes, electrically connected with the corresponding active devices, wherein the auxiliary light-shielding layer is disposed corresponding to at least one of the data lines and the scan lines.

23. The display panel as recited in claim 21, wherein the color filter further comprises a light shielding pattern layer, the first color filter patterns and the second color filter patterns are located between the light shielding pattern layer and the auxiliary light-shielding layer, a light absorption wavelength range of the auxiliary light-shielding layer is different from that of the light shielding pattern layer, a width of the longitudinal cross-section of the auxiliary light-shielding layer is smaller than or equal to a width of the longitudinal cross-section of the light shielding pattern layer, and the light shielding pattern layer is located between the auxiliary light-shielding layer and the display medium.

24. The display panel as recited in claim 21, wherein the color filter further comprises a light shielding pattern layer, the first color filter patterns and the second color filter patterns are located between the light shielding pattern layer and the auxiliary light-shielding layer, a light absorption wavelength range of the auxiliary light-shielding layer is different from that of the light shielding pattern layer, a width of the longitudinal cross-section of the auxiliary light-shielding layer is smaller than or equal to a width of the longitudinal cross-section of the light shielding pattern layer, and the auxiliary light-shielding layer is located between the light shielding pattern layer and the display medium.

25. The display panel as recited in claim 21, wherein each of the boundaries between first color filter patterns and the second color filter patterns has a recess, and the auxiliary light-shielding layer fills the recess.
